(19) United States
(12) Patent Application Publication
(10) Pub. No.: US 2007/0004460 A1
(43) Pub. Date: Jan. 4, 2007

(54) Method and apparatus for non-numeric telephone address

(76) Inventor: Ioannis Tsampalis, Palatine, IL (US)

Correspondence Address: MOTOROLA INC, 600 NORTH US HIGHWAY 45, ROOM AS437, LIBERTYVILLE, IL, 60048-5343, US

(21) Appl. No.: 11/171,547

(22) Filed: Jun. 30, 2005

(51) Int. Cl. H04M 1/00

(52) U.S. Cl. 455/566

(57) ABSTRACT

A communication device (100) allows for entry, storage, retrieval and display of telephone addresses including numeric and non-numeric characters. A translator (404) converts non-numeric characters to numeric characters for transmission to a communication network.

### FIELD OF THE INVENTION

The invention relates generally to communication devices and methods, and more particularly to methods and apparatus for including non-numeric symbols or characters in a telephone address.

### BACKGROUND OF THE INVENTION

To establish a communication link between devices, a user interface on one device is employed for inputting the address of another device with which communication is desired. In the case of telephone devices, such addresses are commonly called telephone numbers and consist of a sequence of numbers. In the case of land-line and cellular telephone addresses, number sequences are required, such that the standard keypad includes 10 number keys and no dedicated text entry keys. It is well known that eight of these keys (those having the numbers 2 through 9) are associated with a plurality of non-numeric characters in addition to numbers. These characters are typically printed either on or adjacent their associated keys. Some communication devices are known to include keypads, such as qwerty keypads, with many additional keys to facilitate text entry.

Communication devices also commonly include an electronic phonebook application, also commonly referred to as an address book or contacts, for phone number storage and retrieval. It is known for the phonebook application to store a telephone number consisting of numeric characters and to associate that telephone number with a non-numeric record, such as a name and/or a voice tag. However, these devices are somewhat limited in how information is input and output.

What is needed is a more flexible and convenient entry, storage and retrieval system for telephone addresses or phone numbers in a communication device.

### BRIEF DESCRIPTION OF THE DRAWINGS

The present invention will hereinafter be described in conjunction with the appended drawing figures wherein like numerals denote like elements.

FIG. 1 illustrates a portable communication device.

FIG. 2 illustrates an alternate portable communication device.

FIG. 3 is a schematic diagram illustrating a wireless communication device and system in block diagram form.

FIG. 4 is a schematic diagram illustrating a portion of a communication device in block diagram form.

FIG. 5 is a diagram illustrating a communication device in further detail.

FIG. 6 illustrates phonebook records.

FIG. 7 illustrates another alternate portable communication device.

FIG. 8 is a flow chart illustrating predictive text input.

FIG. 9 is a flow chart illustrating predictive stroke input.

FIG. 10 is a flow chart illustrating a use case.

FIG. 11 is a flow chart illustrating another use case.

FIG. 12 is flow chart illustrating another use case.

FIG. 13 is flow chart illustrating another use case.

FIG. 14 is flow chart illustrating another use case

FIG. 15 is flow chart illustrating another use case.

### DETAILED DESCRIPTION

A communication device has an input for numeric (for example the numbers 0-9) and non-numeric characters (for example the letters a-z), at least some of the non-numeric characters, or symbols, associated with numbers according to a predetermined relationship. An example of such an association is that found on a standard telephone keypad wherein at least some of the keys represent both numbers and letters. Those skilled in the art will recognize that telephone numbers consist only of the numbers 0-9 and that letters are converted to corresponding numbers prior to encoding for transmission to a network or exchange.

A user enters a sequence of characters representing the address of another communication device to establish a communication link between the devices. An example of such an activity is commonly referred to as “dialing a telephone number.” In many modern communication devices, the sequence of numeric and non-numeric characters is presented in a display for viewing by the user. For communication to a network, the device translates any non-numeric characters in the address sequence into an associated numeric value for use by the communication network to establish a connection. This translated number sequence is then encoded (for example in DTMF tones) for transmission to the communication network. The present device permits entry of an address directly into the device in any format desired by the user, and provides flexibility in the entry, dialing, deletion, retrieval, and/or display of addresses (for example by permitting use of letters, numbers or a combination of letters and numbers in the sequence) to be entered and displayed.

The ensuing detailed description provides preferred exemplary embodiments only, and is not intended to limit the scope, applicability, or configuration of the invention. Rather, the ensuing detailed description of the exemplary embodiments will provide those skilled in the art with an enabling description for implementing the invention. It being understood that various changes may be made in the function and arrangement of elements without departing from the spirit and scope of the invention, as set forth in the appended claims.

In order to provide context for features of the invention, reference numerals introduced in the specification in association with a drawing figure may be repeated in one or more additional figures without a specific reference in the specification to that reference numeral in the additional figures. As used in this specification and the appended claims, the terms “circuit” or “circuitry” are intended to be construed broadly, to include actual analog and digital circuits, as well as software applications and functional portions of software applications.

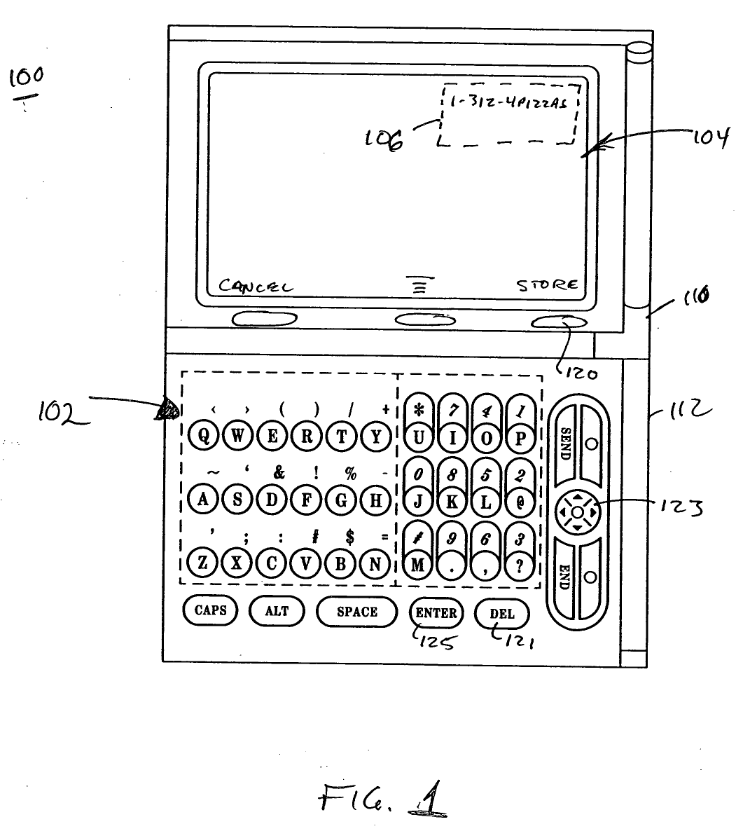

Somewhat more particularly, a communication device 100 (FIG. 1) has an input 102 for entering numeric and non-numeric symbols, or characters. In a dialing mode, the user enters a character sequence representing an address by pressing the appropriate keys of input 102. The input sequence associated with the key presses is presented to the user via display 104, thereby providing visual verification of the key sequence entered. The entered address may for example be displayed in address field 106 of display 104.

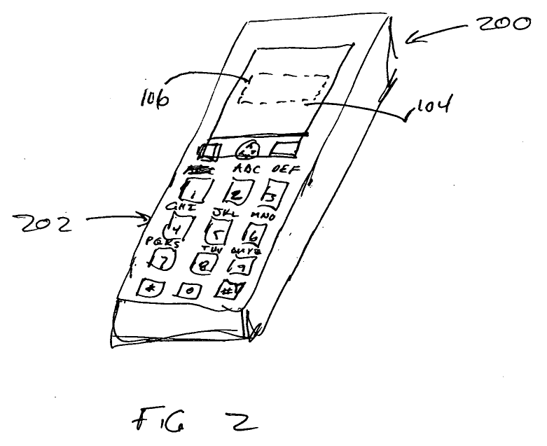

The device 100 is illustrated to be a portable wireless communication device, such as a cellular telephone, a cordless telephone, a messaging device, a personal digital assistant (PDA), or the like. It is envisioned that the device 100 may include a standard telephone keypad 202 (FIG. 2), a so-called “4-by-3 matrix”, “#” or “Bell” keypad, which is a 10-digit, 12-key, keypad such as those found on a standard telephone. The standard keypad telephone 200 includes keypad 202 and display 104 with address field 106. Alternatively, a QWERTY keyboard (such as that illustrated in FIG. 1) of the type found in a computer or type-writer, or any other keyboard or keypad, could be employed. For example, the keyboard input 102 illustrated in FIG. 1 includes a combination of both a 12 key standard telephone number keypad and a QWERTY keypad. Using this keypad, numbers are entered when certain keys generate lower case letters, capitol letters, or numbers in normal, CAPS, or SHIFT mode respectively. Although not illustrated, it is envisioned that the display may include a touchpad such that a separate keypad is not required, or the input may employ a microphone for voice actuated dialing and a speaker for audible output whereby conformation of the input address may be audible as opposed to visual.

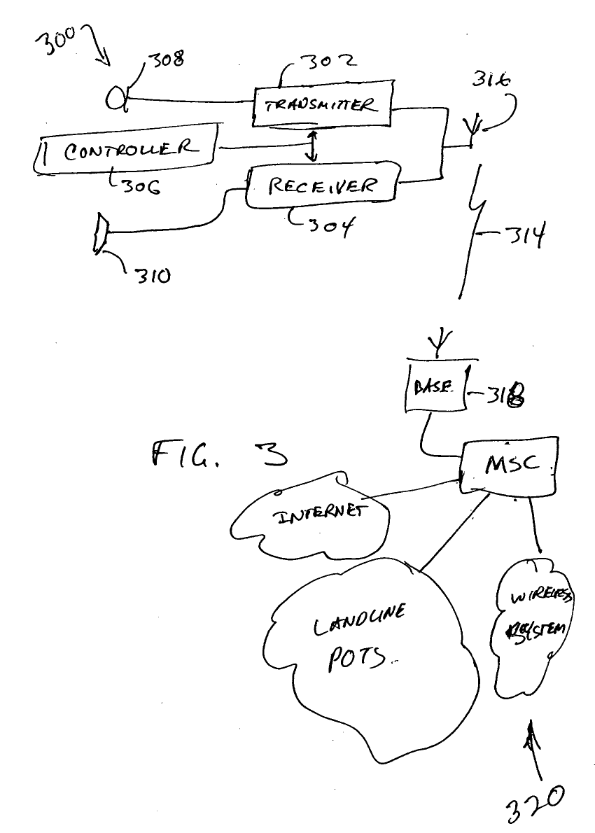

The communication device 100, 200 includes circuitry 300 (FIG. 3) within the device housing 110, 112 (FIG. 1) for communicating with a network 320. The exemplary circuitry 300 is for wireless communication, and generally includes a transmitter 302, a receiver 304, a controller 306, a microphone 308 and a speaker 310. The transmitter 302 and receiver 304 are coupled to another device 318 (exemplary illustration being a base station) via a communication link 314, which in the exemplary embodiment is a wireless communication link, using an antenna 316. Those skilled in the art will recognize that the communication link can be wired or wireless, and further that the signals may be radio frequency signals, or they may be at other frequencies. The device 318 is illustrated connected to a mobile switching center (MSC) which is connected to the internet, landline plain old telephone system (POTS), and a wireless system which may be another MSC or more base stations.

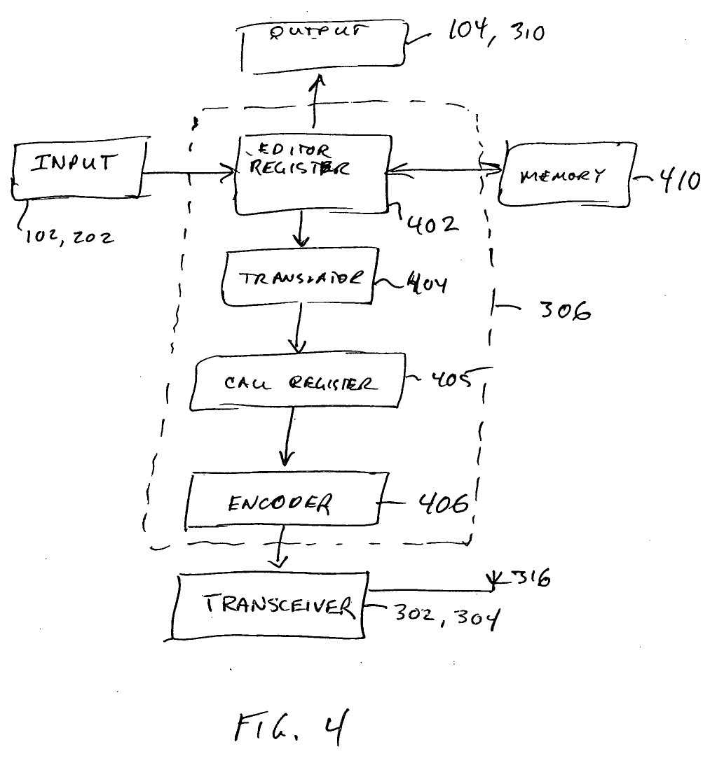

The dialing operation of controller 306 will now be described with reference to FIG. 4. An address is loaded into editor register 402 responsive to the user input 102. The content of the editor register 402 is provided to the user via on output 104. The output 104 will present the character sequence input by the user as it was keyed in. Thus, if the user enters letters and numbers, then letters and numbers will be displayed. In the example of FIG. 1, the user keyed in “1-312-4PIZZAS”, and this is the sequence output in audio through speaker 310 or visually on display 104. The translator 404 translates those input sequence characters which are not properly part of a numeric address into corresponding characters that are properly part of an address sequence. Thus, in the example of FIG. 1, the translator 404 translates the sequence2-312-4PIZZAS to the numeric sequence 13124749927, which sequence can optionally be placed in a call register 405. The proper sequence is encoded in optional encoder 406 if encoding is necessary before transmission to the network (if the network requires an encoded sequence). For example, in a cellular system, the number sequence will be encoded as required by the air interface protocol. In a landline telephone system, the number sequence is translated into a DTMF or pulse coded sequence. The sequence encoded by encoder 406 is transmitted by transmitter 302, which in the exemplary wireless system is via antenna 316.

Those skilled in the art will recognize that in the case of a cellular phone, also known as a “mobile”, it is envisioned that the address in editor register 402 will correspond to a number to be loaded into the call register 405, such that while the is presented a character sequence 1-312-4PIZZAS, the call register 405 contains a digital representation of the number sequence 13124749929. This numeric representation of the telephone number will be transmitted to a base station using any suitable, conventional call processing technique. The device 100 may thus optionally, and advantageously, include a sequence editor associated with the editor register 402 that allows telephone numbers to be entered, edited, dialed, and displayed in alphanumeric format.

The device 100 may also optionally, and advantageously, include a phonebook application that stores the character sequence in memory 410 (FIG. 4) and retrieves the input sequence from memory 410 for display and dialing. Controller 306 can include memory for storing telephone numbers, or a separate memory 410 may be provided that is connected to the controller 306 as illustrated in FIG. 4. As part of the creation of the telephone book within the device, non-numeric characters need not be translated to their respective numeric values until they are communicated to the network. The phonebook application can allow telephone numbers to be entered, stored, edited, deleted, retrieved, dialed, and/or displayed in alphanumeric format (i.e., as a mixture of letters and digits). The user controls retrieval and storage via input 102.

Those skilled in the art will recognize that there are many method of entering a phone number. The following are exemplary techniques, which are not intended to be limiting, for entering an address such as phone number to be dialed:
1. entering digits in the idle display (e.g., “dialing” or direct number entry);
2. selecting a phone number from a call history list stored in memory, (e.g. Recent Dialed Calls List, Recent Received Calls List).
3. retrieving an address using a phonebook application;
4. from a messaging application, selecting the phone number of the sender/recipient of an SMS, MMS, EMS, E-mail (if the messaging application provides link to the Phonebook Application); or
5. selecting a phone number embedded in the message body of an application such as SMS, NMS, EMS, E-mail or an internet browser application.
   Generally, it envisioned that a telephone number can be selected from any application by selecting (highlighting) data and copying it (storing the data) into the phonebook. In operation, it is envision that the phonebook application causes a “Phonebook Detail Edit Entry” to appear on a display screen, where the user can edit one or more fields regarding the new entry, for example by entering a Name, Voice Tag, Phone Number, Type (e.g., work, facsimile, home, mobile), and any other desirable fields to be associated with the “Name” as permitted by the phone book application.

As described briefly above, one application in the communication device 100 is a phonebook. When a user inputs information the input can be a direct input from a keypad, keyboard, touchpad, voice actuated control, or other input, or from another application such as a phonebook, via an idle screen input, or through a messaging application such as SMS or a browser. The input sequence is interpreted by the input interpretation module to generate a signal usable by the user interface module. On the other hand, a phonebook application includes a phonebook record which is stored in memory.

The device 100 may advantageously use a wide variety of characters on the user interface side (102, 202, 402, 410, 104, 310) of the translator 404. Thus the character sequence that is displayed, stored in the phonebook, and retrieved from the phonebook may include numbers, non-numeric characters, or combinations of numeric and non-numeric characters. For example, the user may input via the keypad 102 the address “1-312-4pizzas” as exemplified above. This character sequence can not only be seen on the display in this format, but may also me stored in memory in this format. The user need only enter the phone number in an address field itself without adding a text tag.

Those skilled in the art will recognize that a telephone network will only recognize numeric telephone addresses (i.e., containing symbols from 0-9), while other systems may recognize non-numeric symbols, and thus the actual address sent will depend on the network through which the device is establishing a connection. Additionally, if an address sequence input from user interface input 102 is to be stored in memory 410 for later retrieval, the address sequence is stored as input by the user (i.e., the sequence of numeric and non-numeric characters). When retrieved from memory, the number is displayed to the user in the original format such that it that will be recognized by the user (e.g., 1-3124pizzas). Those skilled in the art will recognize that dashes can be stored, they can be automatically added by the phonebook application as a number sequence is recalled from memory or displayed to the user, or they may be omitted. It will also be recognized that the encoder will not be required in systems that do not require coding of the number sequence.

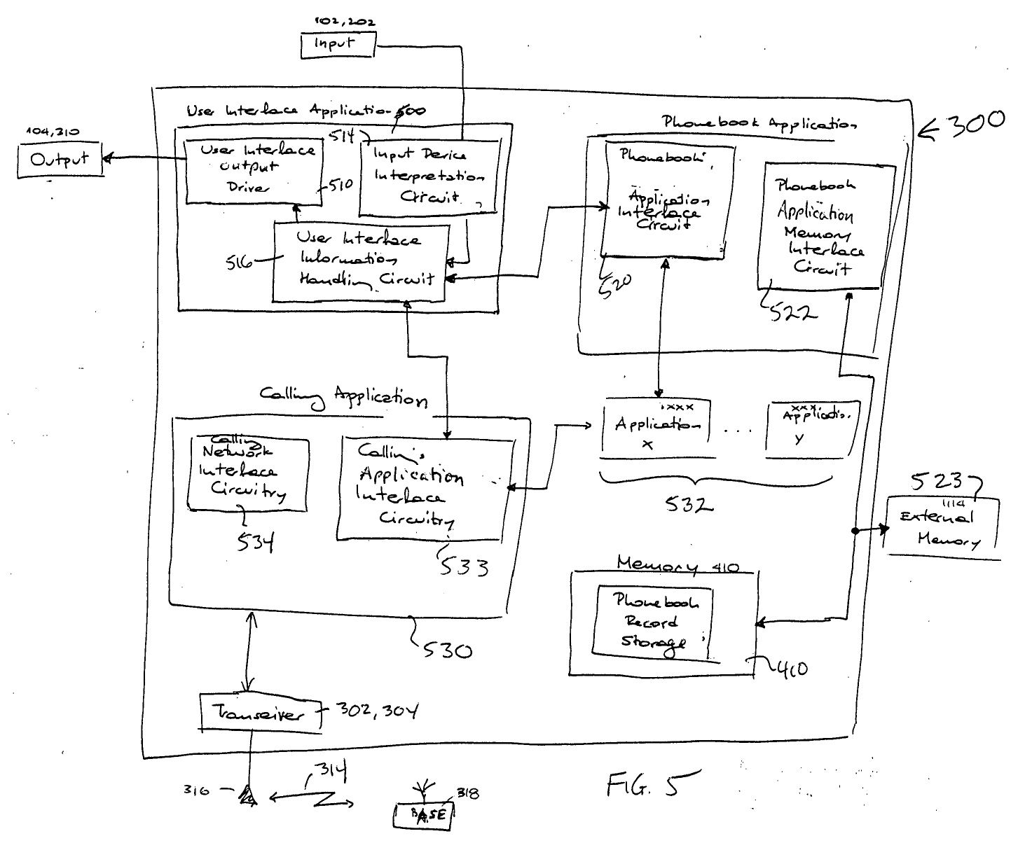

An embodiment of the communication device 100 will now be described in greater detail with respect to FIG. 5, which is an exemplary schematic to illustrate a device in which the invention can be advantageously employed and is not intended to be limiting. The illustrated communication device 100 includes a user interface application 500, a phonebook application 502, other applications 532, a memory 410 for phonebook record storage, a calling application 530, and a transceiver 302, 304, via which the device communicates with a network 320. The user interface application includes an input device interpreter 514 which translates signals from the input 102 and outputs the translated signals to the user interface handler 516. The user interface handler outputs signals to an output driver 518 for output 104 so that information can be provided to the user.

The phonebook application. 502 in the illustrated example is a software application, but could be implemented using shared circuitry or other dedicated circuitry. The phone book application includes an application interface circuit 520 for interfacing with the user interface application 520, phonebook memory interface circuit 522 for interfacing with the phone book memory 410 and external memory 523 having record storage 526 therein, and the phonebook calling interface 524 which can be provided to interface directly with the calling application.

The calling application 530 includes calling application interface circuitry 323 for interfacing with the user interface application 500, the phonebook application 502 and other applications 532. The calling network interface circuitry 534 outputs signals that are useable by the network 320 when transmitted by transceiver 302, 304.

The illustrated communication device is a wireless device that includes an antenna 316 (FIG. 3) for coupling to a base station 318 of network 320 to establish a communication link 314. Although a wireless communication device is illustrated, which may be a cellular telephone, a cordless telephone, a computer such as a tablet, laptop or desktop computer, wireless local area network (WLAN) device, a dispatch radio, or the like, those skilled in the art will recognize that the communication device may be connected via a wired link. Furthermore, the network 312 may be a circuit switched network (e.g., cellular or landline telephone network) or packet switched network (e.g., asynchronous transmit mode or cellular packet data), and can operate according to any suitable communication standard.

More particularly, it is envisioned that the user interface application 500 (FIG. 5) will support input and output of one or more of the following: sounds (e.g., voice and music), data, text, graphics, images, and the like. It is further envisioned that the inputs and outputs may be of the type used by applications on the device, may be exchanged with remote devices (not shown), and/or may be used for controlling operation of the device 100 or the network 320. The input 102 can include one or more of a keypad, a display and touch screen, a camera, a data reader, an electronic jack for porting with another device, a short range wireless link such as a radio frequency transceiver or infrared porting device or the any other suitable input device. The output. 104 can include one or more of a speaker, a display, a touch screen, light generating components, an image projector, an electronic jack for porting with another device, a short range wireless link such as a radio frequency or infrared porting device for transmitting signals to another device, and the any other suitable output device.

The input device interpreter 514 operates with the input 102, and can be implemented using any suitable commercially available software and/or circuitry suitable for use with the input. The output driver 510 is similarly for driving the output 104, and can be implemented using any suitable commercially available software and/or circuitry suitable for use with the output. The user interface handler can be implemented using common circuitry and/or software of the communication device, and thus can be implemented with the calling application 504 circuitry, the phonebook application 502 circuitry, the memory 410 and the circuitry for other applications 532, and more particularly may for example be implemented using software in one or more of a digital signal processor (DSP), microcontroller, microprocessor, a programmable logic unit, or the like. The controller (306 in FIG. 3) may include memory, which may integrated memory, external memory or a combination of integrated and external memory. The memory stores applications, control programs, data, and the like as noted hereinabove. The memory 410 storing phonebook records is provided for illustration purposes only, and stores the phone book records within device 100. This memory may also store a software application for controlling the device to implement phone book dialing (also know as abbreviated dialing). The memory may be internal or external, may be implemented on subscriber identity module (SIM), a smart card, a removable memory card, or any other suitable memory device.

The output driver 510 includes one or more drivers to control the generation of audible and/or visual information via output 104. For example, the output driver may include a driver for the display, which may be any commercially available display, such as a liquid crystal display (LCD) for example. The input device interpretation circuit 514 may be a keypad interface for receiving signals from a conventional telephone, qwerty, or microphone input, and outputs signals indicating which input was actuated. The telephone keypad (102, 2020 shown in FIGS. 1 and 2) can be a telephone keypad having 10 numeric keys (0-9), a # and * key, and additional function keys (e.g., a send key, an end key, navigation keys, softkeys, etc.). The input may also, or alternatively, include a touch-screen or a QWERTY keypad (as shown in FIG. 1), and the input supports such devices. The input may also, or alternatively, receive and precondition audio input signals for use in voice actuated operation.

The memory 410 can comprise any suitable memory, such random access memory, read only memory, electronically erasable read only memory, a subscriber identity module (SIM) of the type used in cellular systems such as those complying with the global system for mobile communications (GSM) and wideband code division multiple access (WCDMA) systems, removable memory cards (Secure Digital cards, Multi-Media Cards, etc.), personal computer memory, a memory stick such as a universal serial bus disc or stick, or the like. It is thus envisioned that the memory may be distributed memory in multiple circuit elements or locations. It is further envisioned that the memory may optionally be within the network 320, such as a server based application that the device communicates with via communication link 314.

The transceiver 302, 304 may be implemented using any suitable transceiver for communicating with another device. The transceiver may be for landline connections, wireless connections, or the like, and may operate according to any communication standard.

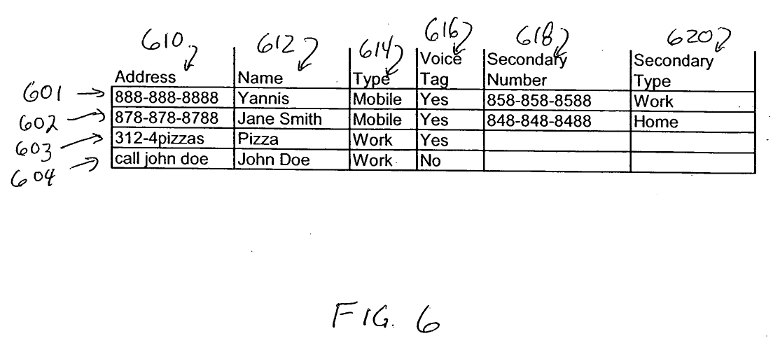

The phonebook records will now be described with respect to FIG. 6. Each entry 601-604 (although 4 entries are illustrated, any number of records can be supported depending on memory size) includes a name field 610 and an address field 612. It may also include an optional type field 614 (e.g., mobile, home, work, etc . . . ), a voice tag field if voice controlled dialing is supported, a secondary telephone number 618 if applicable, and secondary type 620 if a secondary telephone number is included. Other fields can be supported, and these fields are only intended to be exemplary. Depending upon the desired functionality of the communication device 100, any of these fields may be omitted or additional fields may be included. Further, a single field may be provided where the telephone number field 610 is capable of storing alphanumeric telephone numbers, although it is envisioned that a name field will be desired for most users. For example, phonebook record 603 can include only the alphanumeric telephone number “312-4-PIZZAS” in the address 610. Optionally, the user can include the word “Pizza” in the name field 612 associated with the telephone address “312-4-pizzas”.

The operation of the communication device 300 (FIG. 5) will no be described with reference to several examples. The function of the calling application 304 is to translate telephone numbers from the encoding scheme (e.g., Unicode) used by the communication device 100 (including the user interface application 300 and the phonebook application 302) into the encoding scheme used by the network 320. The translated information is transmitted by the transceiver 302, 304 to the network 320. For example, in the Global System for Mobile communication (GSM) the calling application 530 translates Unicode data (e.g., a telephone number) from the phonebook application 502 into BCD (Binary Coded Decimal) for transmission over a GSM network. Conversely, incoming BCD transmissions from the network 320 is received by the transceiver 302, 304 and the calling application 530 translates it to the format used by the communication device 300.

In the embodiment of FIG. 2, a standard telephone including a 12 key keypad is illustrated. As can be seen the following is the relationship between letters in the English alphabet and digits on a standard cellular telephone keypad of the type used in North America:

the letters A, B and C correspond to the number 2;

the letters D, E and F correspond to the number 3;

the letters G, H, and I correspond to the number 4;

the letters J, K and L correspond to the number 5;

the letters M, N and 0 correspond to the number 6;

the letters P, Q, R and S correspond to the number 7;

the letters T, U and V correspond to number 8; and

the letters W, X, Y and Z correspond to the number 9.

In order to simplify programming and to allow use of a standard telephone-style keypad as the input device 102, the alphanumeric character set is restricted to digits (numbers), letters, and a plus (+) symbol at the beginning of the telephone number (for international telephone numbers). This embodiment of the communication device 10 is programmed for English, so the alphanumeric character set includes the plus symbol, digits “0”, through “9” and the letters “A” through “Z” in both uppercase and lowercase. The communication device 10 could be programmed for other languages, or could even be programmed for multiple languages. In such embodiments, the digits and letters in the alphanumeric character set would include the digits and letters from the appropriate language(s). As used herein, an “non-numeric address” or an address in “non-numeric format” means a sequence, such as a telephone number, that includes both numeric and non-numeric characters, and may include other characters such as the plus (+) or dash (−) symbols, and/or one or more pauses (often represented by an “f” or “p”). Conversely, a “numeric address” or an address in “numeric format” is a address that includes only numbers, and may include a plus (+) symbol, a dash (−) symbol, and/or one or more pauses.

FIG. 1 shows the display 104 in an idle mode (i.e., the display mode used when no functions are being performed by the user) the telephone number “312-4-PIZZAS” has been entered using input 102. From this state, the user can press the send key to transmit the number, store the telephone number by pressing “store” soft key 120, or edit the number using delete key 121 or navigation key 123. Alternatively the store function can be initiated responsive a soft key (a key whose function is dynamically changed depending on the mode of the device), a touch screen implemented switch, a dedicated switch, or any other suitable switch. If the store function is initiated, a phonebook record detail mode is entered as illustrated by display 104 with the telephone number entered in the telephone number field 610. According to one embodiment, the number can be stored directly without entering any additional information by pressing “enter” key 125.

Throughout the telephone number entry, retrieval and dialing process, the user interface application 500 and the phonebook application 502, are each capable of handling non-numeric address sequences. In order to allow alphanumeric telephone numbers to be entered and stored in the telephone number field 106, it is necessary for the telephone number field 106 of the memory device 410 to be configured to store alphanumeric characters. The phonebook memory interface 522 is also designed to encode and decode all of the characters of the alphanumeric character set.

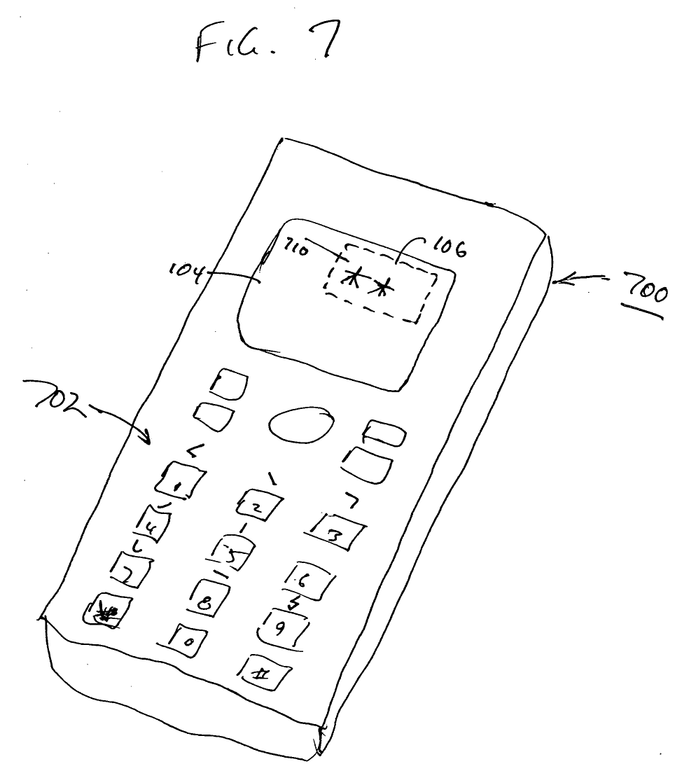

FIG. 7 illustrates another exemplary device 700. It is envisioned that the present invention can be implemented for any language, using common symbols. Device 700 has a common 4-by-3 matrix telephone keypad. In the illustrated embodiment, some of the 10 numeric keys 0-9 have an associated respective Chinese stroke. Those familiar with Chinese stroke entry will recognize that a character is made up of a predetermined sequence of strokes, wherein the order of stoke entry is predefined, or known. For example, the keys 85428542 are actuated by the user to input a stroke sequence which results in the character 710 of FIG. 7 being entered into the editor register 402. From this register, the sequence can be stored as a phone number in a telephone number field 610 of the phonebook application, displayed on the display 106 as shown in FIG. 7, or sent to the translator 404. In the translator 404, the character will be unambiguously translated to 85428542. In this manner it can be seen that one or more Chinese characters can represent an entire telephone address.

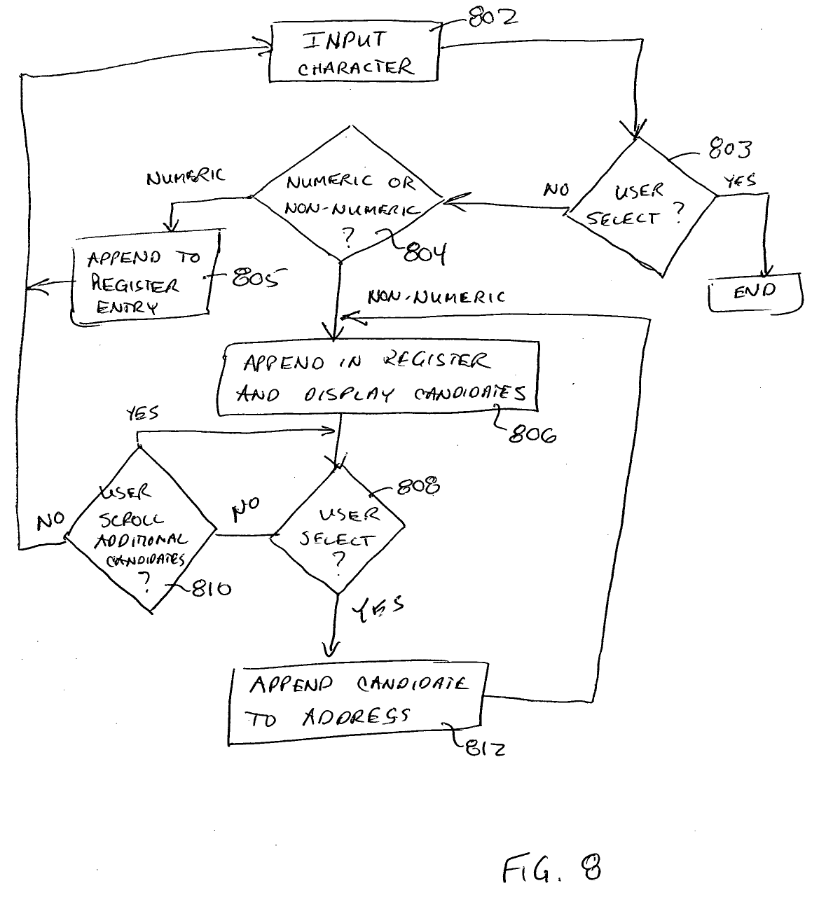

It is further envisioned that predictive software can be used to disambiguate user inputs and reduce the number of key presses required to enter a word or character. With reference now to FIG. 8, the predictive text operation will be described in greater detail. Upon entry of a character in step 802, the controller 306 determines in step 803 whether the user is done (e.g., user inputs send or store). If not, the controller 306 determines if the character is numeric or non-numeric in step 804. Examples of non-numeric characters include letters, strokes, or other symbols representing words. If the character is a number, the number is loaded into the editor register 402 as indicated in step 805. If the character is not a number, the. character is stored in the editor register and a list of candidate words or symbols is presented to the user for selection as indicated in step 806. It is envisioned that the most common words or symbols that use the non-number sequence in the editor register will be presented first to the user. If the desired word or symbol is not presented, the user may either enter another character at step 802 to be combined with the previously entered character or scroll through additional selections in step 810 to search for the desired symbol or word. When the desired candidate is displayed and selected at step 808, the candidate is appended to the editor register 402 by controller 306. Predictive text programs are known and commercially available, and will not be described in greater detail herein as any such software algorithms may be utilized without deviating from the invention.

In operation, if a user is entering 1-312-4pizzas, the user would enter a 1, followed by a 3, followed by a 1, followed by a 2, followed by a 4. As each of these numbers is entered via the input, the number is loaded into the editor register. The user can then enter a “p”. Upon entering a “p”, the most common words having a p will be displayed to the user. If pizza is not displayed as an option, the user continues to enter letters until the entire word is entered or pizza is displayed as a choice. When pizza appears as a choice, the user can quickly scroll to the word and select it, responsive to which the controller 306 will load the word to the editor register.

It is envisioned that once the user selects “pizza”, the candidate words including pizza as a root, such as “pizzas” and “pizzeria” would be displayed. The user could then scroll to the desired word “pizzas” and when highlighted press the enter key. Alternatively, the user can enter an “s” as the next character to complete the number. With the editor register loaded, the user can proceed to execute a command, such as saving the contents of the editor register in memory, or pushing a “send” key causing the telephone number corresponding to the entered sequence to be transmitted to the network for completing a call.

Such a predictive application is particularly advantageous in situations such as stroke entry. Because of the substantial number of characters used in various stroke writing systems, such as Chinese stroke systems, a predictive stroke entry application can be used to present candidate characters as strokes are input. As strokes are input, the number of candidate characters is reduced. At any time during the process, the user is able to scroll though candidate characters and select from the list the character that they are interested in. In this manner, a character may be displayed and selected without entering the entire stroke sequence for the character. The character will be displayed such that the user need not enter the entire stroke sequence to load the full sequence associated with a character into the editor register. Once the user selects the character from a list of candidates, the entire stroke sequence associated with the character is moved into the editor 302. Predictive stroke software is commercially available from a variety of companies, and will not be described in greater detail herein for brevity.

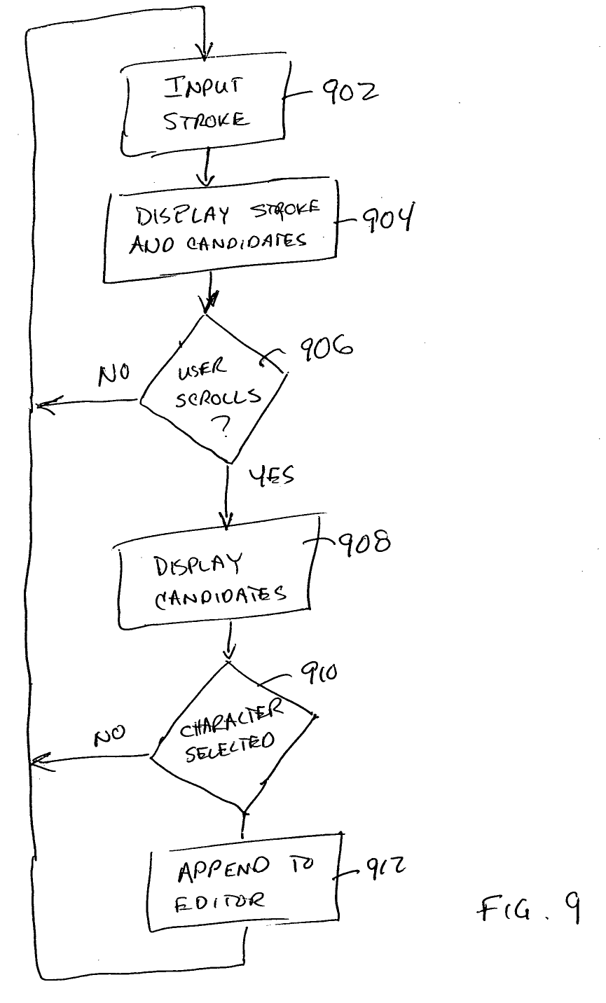

Stroke entry operation will now be illustrated with respect to FIG. 9. Upon entry of a stroke in step 902, controller 306 determines the most likely characters associated with the stroke sequence and displays the most likely characters. The character is stored in the editor register and a list of candidate words or symbols is presented to the user for selection as indicated in step 904. If the desired word or symbol is not presented, the user may either enter another stroke at step 902 to be combined with the previously entered character or scroll through additional selections in step 906 to search for the desired symbol or word in step 908. When the desired character is displayed and selected at step 910, the candidate is appended to the editor register 912 by controller 306. The user may then append additional strokes to construct a more complex symbol, append another symbol to the symbol or symbols in the editor, store the contents of the editor in memory, or transmit the contents of the number editor by pressing the send key. It is envisioned that numbers can be optionally combined with stroke characters in the call register editor.

It will be recognized that when the character is recalled from memory, the character will be displayed, and optionally the number sequence associated with the character. When the user actuates the “send” key, the entire number sequence associated with the character set will be transmitted even if the entire sequence was not entered initially when selecting the character.

Thus, it is envisioned that the telephone number can be entered in a number of different ways. The user selects predictive text mode to complete words or characters, number mode may be used to enter conventional phone numbers, or a combination of numbers and characters can be entered as the phone number. In predictive text mode the user presses keys to enter strokes until the desired character or word is selected from a list. In the stroke and number mode, the user selects strokes until the desired character is described and enters numbers when appropriate. When the address is fully described using numbers and characters, the number is stored in memory.

It is envisioned that an advantageous method of storing telephone numbers is from text messages. A telephone number may appear in the text of an internet page, a received text message, an electronic advertisement, email message, or the like. In operation, the user selects the address sequence (for example by highlighting the address sequence using the cursor). The number may be in numeric format, non-numeric format, or a combination of numeric and non-numeric characters. Once selected, the user can copy the sequence directly into their phone book number field using conventional means, such as highlighting the sequence and copying it to the phone number area of the display. The sequence located in the phone number area of the display will be automatically loaded,in the phone number register. When the user presses the send key, the translator automatically translates the number into numeric form, and dials without the user having to manually enter each character, and furthermore without the user having to manually translate non-numeric characters to numeric characters to enter the phone number.

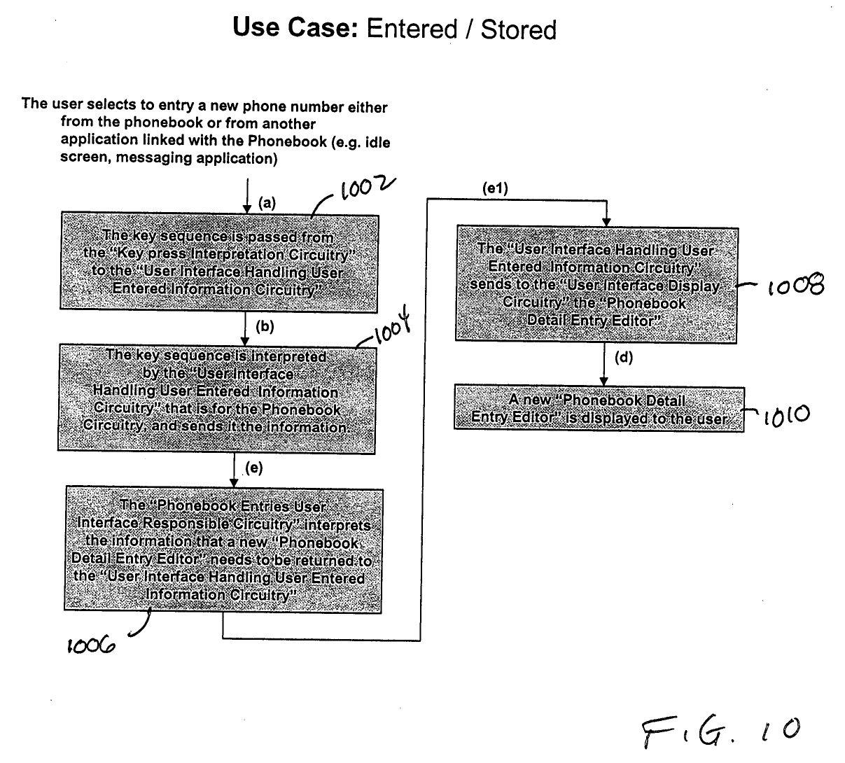

Several use cases will now be described. The first use case will be described with respect to FIGS. 5 and 10. The user enters a number either from the phonebook application 502 or from another application as linked with the phonebook application. Examples include entry into an idle screen (the telephone when the telephone is initially turned on), retrieval from phonebook memory, or copying from a browser or messaging application. The input device interpretation circuit 514 will interpret the user inputs and supply them to the user interface information handling circuit 516 as indicated in step 1002. The key sequence interpreted by the user interface information handling circuit 516 as being for the phonebook application 502 is communicated to the phonebook application as indicated in step 1004. The phonebook memory interface circuit 1108 interprets that information that a new phonebook detail entry editor needs to be returned to the user interface information handling circuit 516 as indicated in step 1006. The user interface information handling circuit 516 sends the information to the phonebook detail entry editor as indicated in step 1008. A new Phonebook Detail Entry Editor is displayed to the user as indicated in step 1010 whereby the user can create the appropriate details.

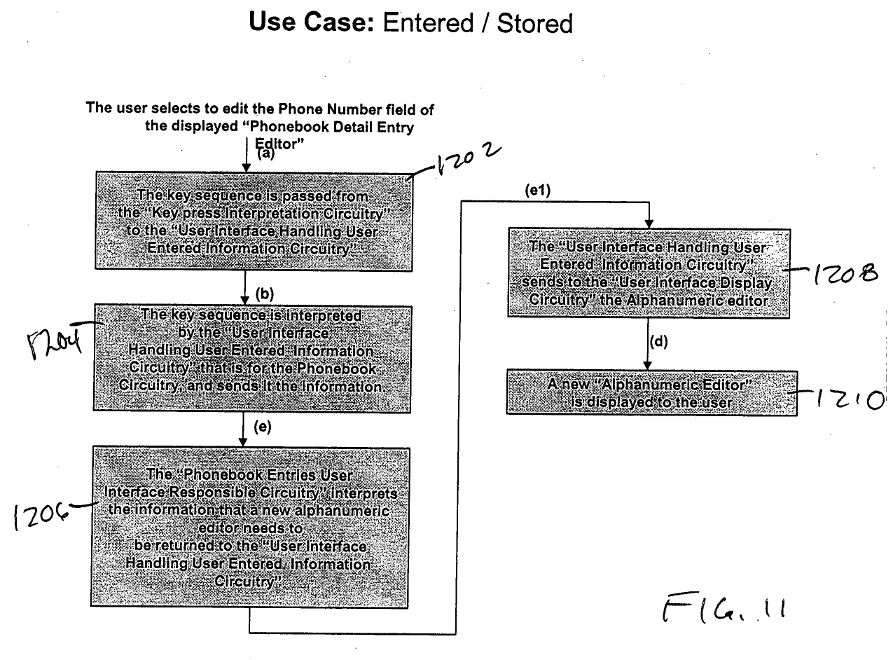

A second use case will now be described with respect to FIGS. 5 and 11. The user selects to edit the phone number field of the displayed Phonebook Detail Entry Editor. The key sequence is passed from the input device interpretation circuit 514 to the user interface information handling circuit 516 as indicated in step 1202. The key sequence is interpreted by the user interface information handling circuit 516 that it is for the phonebook application 502 and sends the phonebook application information as indicated in step 1204. The phonebook memory interface circuit 522 interprets that a new alphanumeric editor needs to be returned to the user interface information handling circuit 516 as indicated in step 1206. The user interface information handling circuit 516 sends the user interface output driver 510 the alphanumeric editor information as indicated in step 1208. A new alphanumeric editor is displayed to the user as indicated in step 1210.

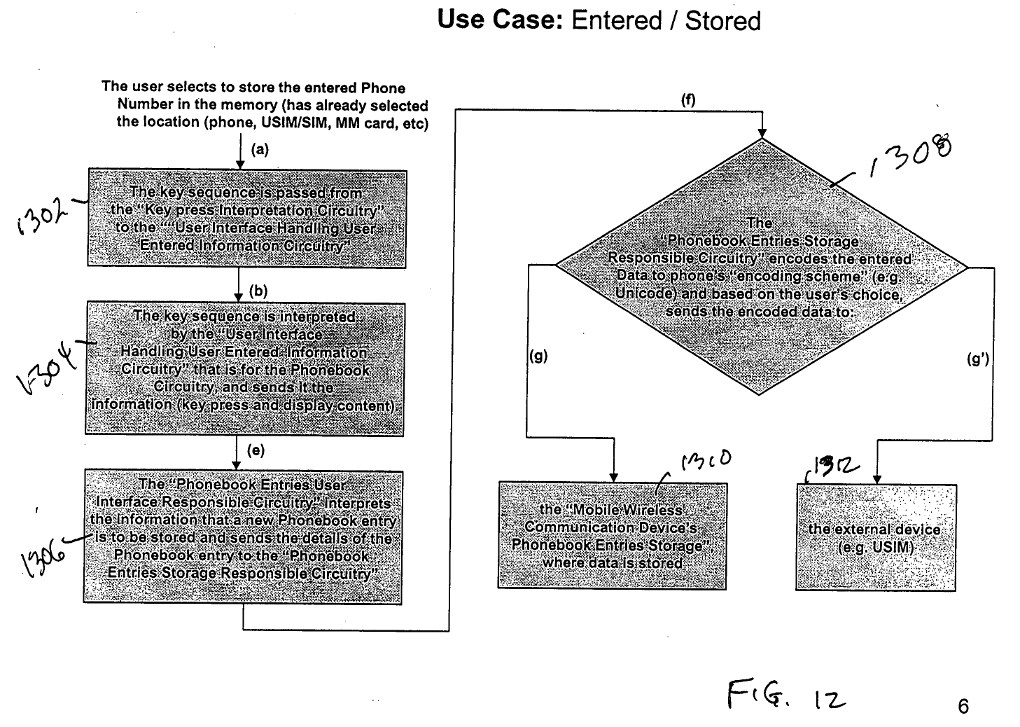

A third use case will now be described with respect to FIGS. 5 and 12. The user selects to store the entered phone number in memory (the user has already selected the location (phone, SIM, USIM, memory card, smart card, or the like)). The key sequence is passed from the input device interpretation circuit to the user interface information handling circuit 516 as indicated in step 1302. The key sequence interpreted by the user interface information handling circuit 516 as being for the phonebook application is sent to the phonebook application (e.g., key press and display content) as indicated in step 1304. The phonebook memory interface circuit 522 interprets information indicating that a new phonebook entry is to be stored and sends the details of the phonebook entry for storage as indicated in step 1306. The phone book memory interface circuit encodes the entered data to the phone's encoding scheme (e.g. Unicode) and based on the user's choice determined at step 1308, sends the encoded data to either the mobile device's phonebook record storage 526, where data is stored as indicated in step 1310, or to the external memory device 523 (e.g. SIM) as indicated in step 1312.

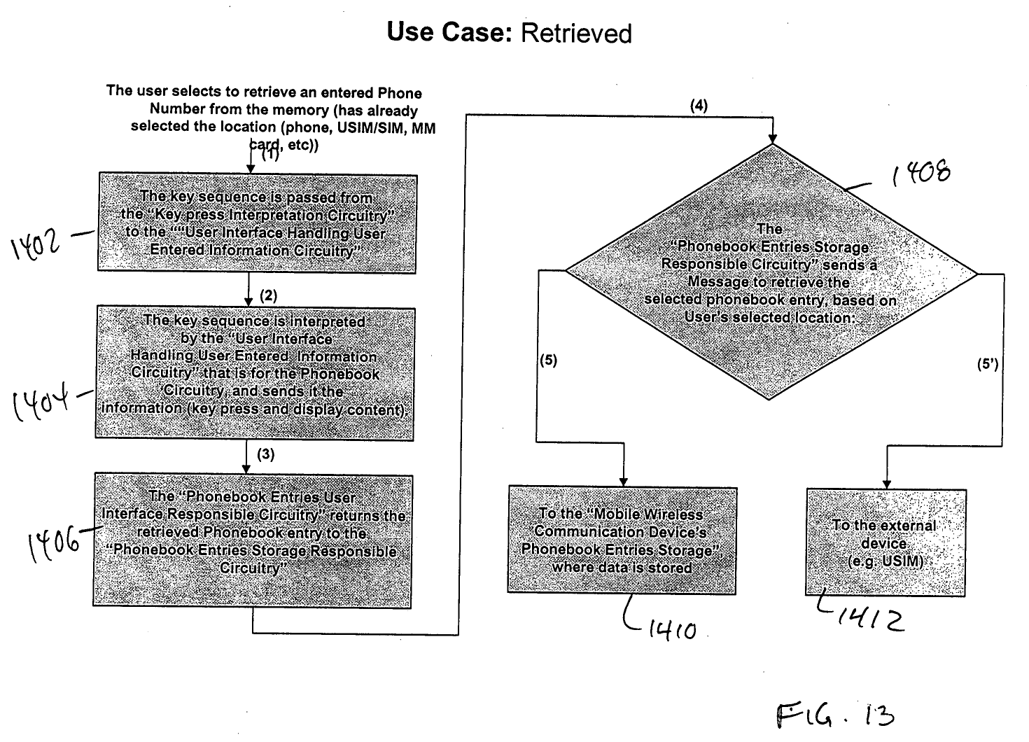

A forth use case will now be described with respect to FIGS. 5 and 13. The user selects to retrieve an entered telephone address from the memory 410, 523 (has already selected the location phone, SIM, USIM, memory card, smart card, or the like). The key sequence is passed from the input device interpretation circuit 514 to the user interface information handling circuit 516 as indicated in step 1402. The key sequence interpreted by the user interface information handling circuit 516 as being for the phonebook application 502 is communicated to the phonebook application interface circuit 520 (e.g., key press and display content) as indicated in step 1404. The phonebook memory interface circuit 522 returns the retrieved phonebook entry to the phonebook memory interface circuit 522 as indicated in step 1406. The phonebook memory interface circuit 522 sends a message to retrieve the selected phonebook entry, based on the user's selected location, as determined in step 1408, either from the memory 410 where data is stored as indicated in step 1410 or from the external memory (e.g. USIM) 523 where the data is stored as indicated in step 1412. In this way, data is retrieved from memory into the call register.

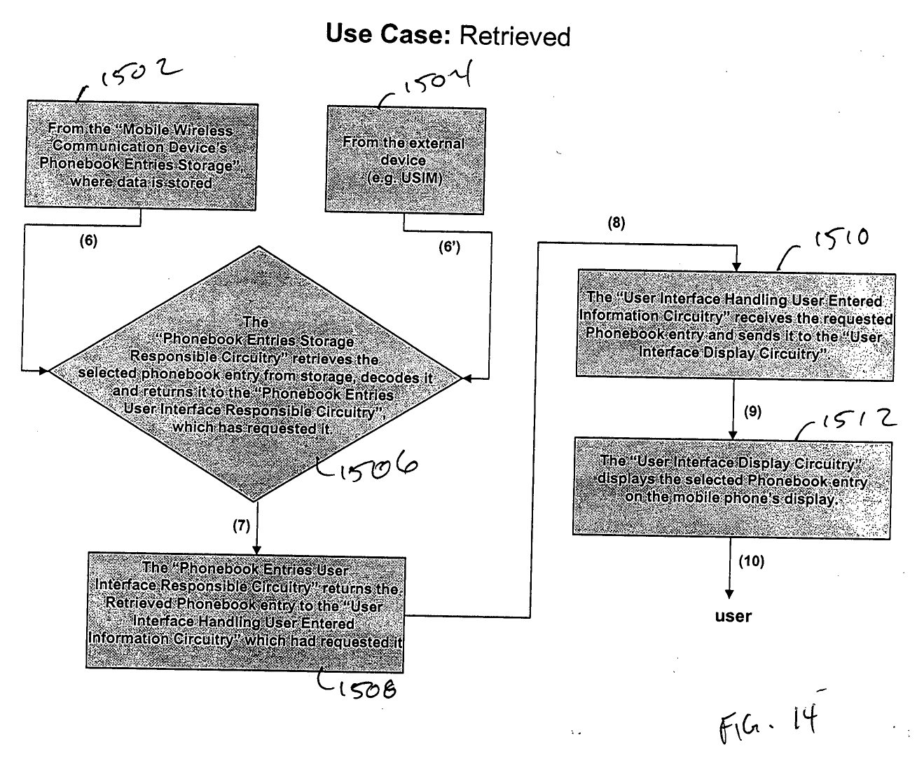

A fifth use case will now be described with respect to FIGS. 5 and 14. Information is retrieved from memory 410 as indicated in step 1502 or from an external device (e.g. USIM) 523 as indicated in step 1504. The phonebook memory interface circuit 522 retrieves the selected phonebook entry from storage, decodes it as requested as indicated in step 1506. The phonebook memory interface circuit 522 returns the retrieved phonebook entry to the user interface information handling circuit 516 which had requested it as indicated in step 1508. The user interface information handling circuit 516 receives the requested phonebook entry and controls the user interface output driver 510, as indicated in step 1510, to control the output 104, 201 to provide the selected phonebook entry to the user as indicated in step 1512.

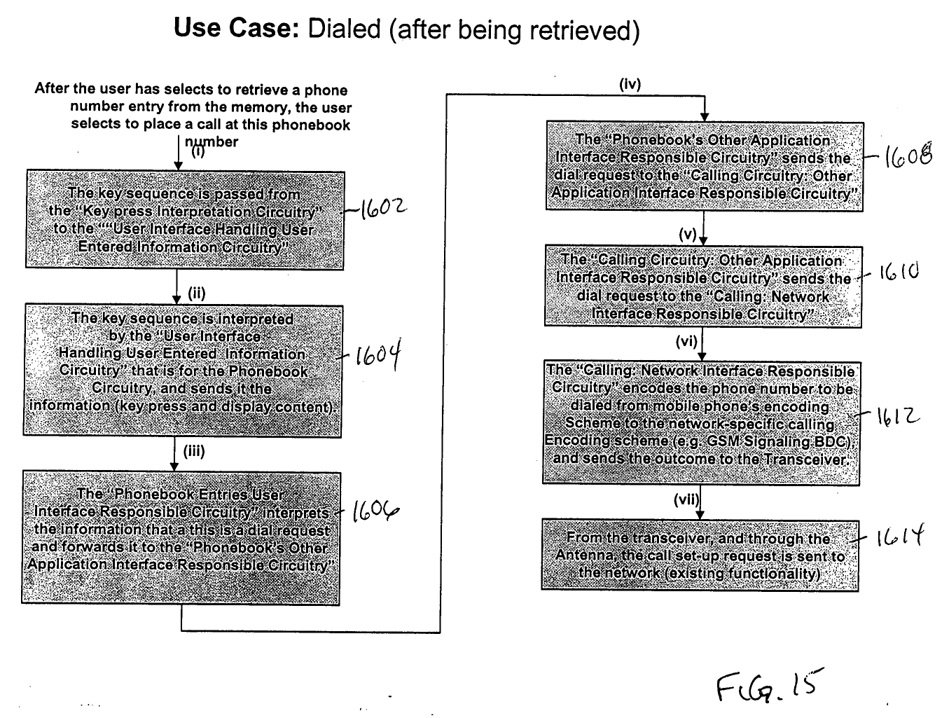

A sixth use case will now be described with reference to FIGS. 5 and 15. After the user has elected to retrieve a phone number entry from the memory 410, the user selects to place a call from this phonebook. The key sequence is passed from the input device interpretation circuit 514 to the user interface information handling circuit 516 as indicated in step 1602. The key sequence is interpreted by the user interface information handling circuit 516 as being for the phonebook application 502, responsive to which the information (key press and display content) is sent to the phonebook application as indicated in step 1604. The phonebook interpretation circuit 522 interprets the information as being a dial request and forwards it to the other applications 532 as indicated in step 1606. The other applications 532 sends a dial request to the calling application interface responsible circuitry 533 as indicted in step 1608. The calling application interface responsible circuitry 533 sends the dial request to the calling network interface circuit 534 as indicated in step 1610 calling network interface circuit 534 encodes the phone number according to the mobile phone's network-specific calling encoding scheme (e.g. GSM Signaling BDC), and sends the resulting encoded signal to the transceiver 302, 304 as indicated in step 1612. From the transceiver, and through the antenna, the call set-up request is sent to the network 320 via base 318 as indicated in step 1614.

While the principles of the invention have been described above in connection with preferred embodiments, it is to be clearly understood that this description is made only by way of example and not as a limitation of the scope of the invention.

1. A communication device including a transmitter, comprising:
a phone number editor for a telephone number sequence, the telephone number sequence including numeric and non-numeric characters;
a memory coupled to the phone number editor for storing the telephone number sequence including numeric and non-numeric characters;
a translator coupled to the transceiver and at least one of the non-numeric phone number editor and the memory, the translator receiving the non-numeric sequence of symbols representing a phone number and automatically translating non-numeric characters in the input address sequence to associated numeric characters and generating a resulting address for communication by the transceiver to a remote station.

2. The communication device of claim 1, further including a display coupled to the phone number editor to, the display visually presenting the sequence of numeric and non-numeric characters to the user.

3. The communication device of claim 2, further including a controller coupled to the display and the memory, the controller controlling the presentation on the display of the sequence of numeric and non-numeric characters stored in the memory whereby the user can select the displayed sequence of symbols for retrieval.

4. The communication device of claim 1, further comprising an encoder, the encoder coupled to the translator, the encoder operable to encode the resulting address output by the translator prior to transmission.

5. The communication device of claim 4, wherein the encoder encodes the numeric address from the translator according to the encoding scheme of a communication network with which the communication device is operable.

6. The communication device of claim 1, wherein the translator is coupled to the memory to receive a number sequence retrieved from the memory.

7. The communication device of claim 1, wherein the input includes a standard 3 by 4, 10 digit telephone keypad, at least some keys of the keypad having numbers and non-numeric characters associated therewith.

8. The communication device of claim 1, wherein the controller controls storage of the telephone number in a numeric and non-numeric format in a call history list for later review.

9. The communication device of claim 1, further including a controller, the controller operable to predict characters in a sequence partially entered in the phone number editor.

10. A wireless communication device comprising:
a user interface for inputting and outputting information to a user;
a transmitter sending data to a communication system;
a controller for receiving an input from the user interface and controlling the outputting of information through the user interface, the controller for receiving telephone numbers including numeric and non-numeric characters, at least some non-numeric characters associated with at least one number, and the controller translating non-numeric characters to associated numbers for transmission by the transmitter.

11. The wireless communication device of claim 10, wherein the storing and retrieving means retrieves the first telephone number from the telephone number record and forwards the first telephone number in the alphanumeric format to the detecting, interpreting and controlling means, which causes the first telephone number to be displayed in the alphanumeric format on the display device.

12. The wireless communication device of claim 10, further comprising a first encoding scheme, wherein the storing and retrieving means translates the first telephone number into the first encoding scheme.

13. The wireless communication device of claim 10, further comprising means for translating the first telephone number from the alphanumeric format to a second telephone number that is in numeric format, wherein each of the at least one letter in the first telephone number is replaced in the second telephone number by a digit according to a predetermined translation scheme.

14. The wireless communication device of claim 13, wherein the wireless network uses a second encoding scheme, and the translating means translates the second telephone number into the second encoding scheme.

15. The wireless communication device of claim 13, wherein the predetermined translation scheme is as follows:
the letters A, B and C are replaced with the number 2;
the letters D, E and F are replaced with the number 3 ;
the letters G, H, and I are replaced with the number 4;
the letters J, K and L are replaced with the number 5;
the letters M, N and O are replaced with the number 6;
the letters P, Q, R and S are replaced with the number 7;
the letters T, U and V are replaced with the number 8; and
the letters W, X, Y and Z are replaced with the number 9.

16. The wireless communication device of claim 10, wherein at least one letter of the first telephone number is limited to the alphanumeric character set consisting of a plus (+) sign and letters of the alphabet.

17. A method of operating a communication device, the method comprising the steps of:
loading and address sequence including non-numeric characters into a register; and
presenting the input sequence including non-numeric characters to the user for use in identifying the address to be called;
automatically translating any non-numeric characters to one or more respective numeric characters, wherein non-numeric characters are replaced by at least one number, to produce a translated numeric sequence; and
transmitting the translated numeric sequence.

18. The method of claim 17, further comprising storing the first telephone number in the memory device in a manner that preserves the alphanumeric format.

19. The method of claim 17, further comprising encoding the first telephone number using the encoding scheme used by the wireless communication device in the alphanumeric format.

20. The method of claim 17, further comprising retrieving the first telephone number from memory and displaying the first telephone number in the alphanumeric format on the display device.

21 A telephone, comprising:
a user interface, the user interface including a call register for a telephone number including numeric and non-numeric characters and an output for the user confirming the numeric and non-numeric characters in the telephone number register; and
an translator coupled to the call register, the translator receiving a sequence of characters from the call register and translating non-numeric characters in the register to their respective associated numeric characters for communication to the telephone system.
